(19) United States
(12) Patent Application Publication
(10) Pub. No.: US 2011/0298980 A1
(43) Pub. Date: Dec. 8, 2011

(54) RESIZING TV GRAPHIC ELEMENTS AND REORIENTING GRAPHICS PLANE FOR USER POSITION

(75) Inventors: Suranjit Adhikari, San Diego, CA (US); Eric Hsiao, San Diego, CA (US)

(73) Assignee: SONY CORPORATION

(21) Appl. No.: 12/795,993

(22) Filed: Jun. 8, 2010

(51) Int. Cl. H04N 5/44; H04N 5/445; G06F 3/00; G09G 5/00

(52) U.S. Cl. 348/561; 348/734; 725/38; 345/649; 345/660; 348/E05.096

(57) ABSTRACT

The size of UI elements on a TV display are enlarged responsive to a determination from sensors that a viewer is beyond a nominal distance from the TV. As well, the graphics plane in which the UI elements are presented can be rotated relative to the video plane to account for a viewer being positioned at an oblique angle relative to the plane of the display.

### I. Field of the Invention

The present application is directed to resizing TV graphic elements and reorienting the TV graphics plane to account to varying user positions relative to the display.

### II. BACKGROUND OF THE INVENTION

Modern electronic products such as TVs increasingly rely on user-friendly, attractive user interfaces (UI) and ease of user experience for product success. As understood herein, a simple and easy to use user interface brings a product to life and allows the consumer to build a relationship with the product and the brand that often spans over an extended period of time.

As recognized by the present principles, however, no matter how attractive and user-friendly a UI is, when the UI is a device such as a TV from which the viewer can position himself at varying distances and angles while still watching the TV, menu options on UIs do not scale, resulting in harder to see and harder to use UIs as the viewer moves away from the TV. As further recognized herein, this problem is compounded by new free pointer remote control (RCs) in which the use of free pointer RC relies on accurate placement of the pointer beam within certain screen areas, a task that is complicated when a viewer moves away from the TV. In other words, the further away from the TV the viewer is located, is the harder it becomes to control the free pointer RCs to select menu items on a UI.

### SUMMARY OF THE INVENTION

Accordingly, a TV includes a display defining a display plane and a normal to the display plane. A processor communicates with a TV tuner and controls presentation on the display. A computer readable storage medium is accessible to the processor and stores logic causing the processor to present user interface (UI) elements in a graphics plane presented on the display along with a video plane presenting video content. The UI elements are presented in a nominal size and nominal layout. Responsive to a determination that a viewer is positioned at an oblique angle relative to the normal, the graphics plane is rotated relative to the video plane.

In some embodiments, the logic can cause the processor to enlarge the UI elements from the nominal size responsive to a determination that a distance between the viewer and TV exceeds a nominal distance. If desired, the logic may cause the processor to rearrange UI elements in the graphics plane relative to each other responsive to a determination that a distance between the viewer and TV exceeds a rearrange distance. Under these circumstances fewer UI elements may be shown than are shown in the nominal layout.

In example implementations, responsive to a determination that a distance between the viewer and TV exceeds a nominal distance, the logic may cause the processor to add to the UI arrows indicating that additional unshown UI elements are available for display. The TV processor may receive a viewer distance determination from a remote control (RC) wirelessly communicating commands to the TV. The processor may also or alternatively receive image signals from a camera on the TV and responsive thereto determine a viewer angle relative to the normal. Still further, the processor may receive command signals from plural wireless command signal receivers on the TV chassis. Based on time differences between receipt of signals from the respective receivers, the processor can determine a viewer distance and/or angle from the TV.

In another aspect, a method includes determining a distance of a viewer from a TV and based on the distance, altering a size of a user interface (UI) element presented on a display of the TV. The method also includes undertaking at least one of the following: responsive to a determination that the distance exceeds a rearrange distance, rearranging UI elements on the display relative to each other, and/or responsive to a determination of a viewer angle relative to a normal to a plane defined by the display, altering an apparent angle at which UI elements are made to appear on the display.

In another aspect, an assembly has a display receiving video signals, a processor communicating with the display, and computer readable medium bearing instructions executable by the processor to, responsive to a determination that a distance between a viewer and the assembly exceeds a rearrange distance, rearrange user interface (UI) elements on the display relative to each other. Also, the logic causes the processor to, responsive to a determination of a viewer angle relative to a normal to a plane defined by the display, alter an apparent angle at which UI elements are made to appear on the display.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a screen shot of a UI presented in a nominal mode;

FIGS. 3 and 4 are screen shots of the UI modified to account for user position beyond the nominal distance and angle;

FIG. 5 is a flow chart of example logic in accordance with present principles; and

FIGS. 6 and 7 are schematic diagrams illustrating example geometries that one embodiment of present principles may assume exist.

### DETAILED DESCRIPTION OF THE PREFERRED EMBODIMENT

Referring initially to FIG. 1, an assembly 10 is shown which includes a TV chassis 12 bearing a TV display 14 such as a standard definition and/or high definition matrix display. The display 14 presents video from a TV tuner 16 which may be in the chassis 12 as shown or which may be implemented in a separate set-top box. The TV tuner 16 receives TV signals from one or more TV sources including satellite receivers, cable head ends, and terrestrial broadcast transmitters.

A TV processor 18 communicates with the TV tuner 16 and with the display to control presentation on the display. The TV processor 18 accesses one or more computer readable storage media 20 such as but not limited to disk-based and/or solid state storage to execute instructions thereon. Among other things the media 20 may store code embodying present logic as well as a graphics module 22, which is executed by the TV processor 18 to present, in accordance with present principles, a graphics plane showing user interfaces (UI) onto a video plane that shows TV programming.

The TV processor may also communicate with a network interface 24 within the chassis 12. The network interface 24 may be, without limitation, a wired or wireless modem or other appropriate interface to communicate with a wide area network such as the Internet 26, from which additional content such as Internet Protocol TV (IPTV) content, “widgets”, etc. may be downloaded.

In some embodiments discussed further below, a camera 28 may be mounted on the chassis 12 and the axis of view of the camera 28 may be normal to the plane of the display 14. The processor 18 in such an embodiment receives image signals from the camera 28. Furthermore, at least one and in some embodiments plural wireless command receivers 30 are arranged on the chassis 12 for receiving wireless commands from a remote control (RC) 32. The wireless command receivers 30 may be radiofrequency or infrared (IR) receivers which send received command signals to the TV processor 18. When plural receivers 30 are provided they may be arranged in a horizontal pattern across the chassis 12, a triangular pattern on the chassis, etc.

A user can input user control signals to the processor for selection and cursor navigation using the RC 32. In the embodiment shown the RC 32 includes a portable lightweight plastic housing 34 supporting user keys 36 communicating with an RC processor 38 accessing a RC storage medium 40. The RC processor 38 responsive to user manipulation of the keys 36 sends wireless command signals to the TV via a wireless (e.g., IR) transceiver 42 on the RC housing 34.

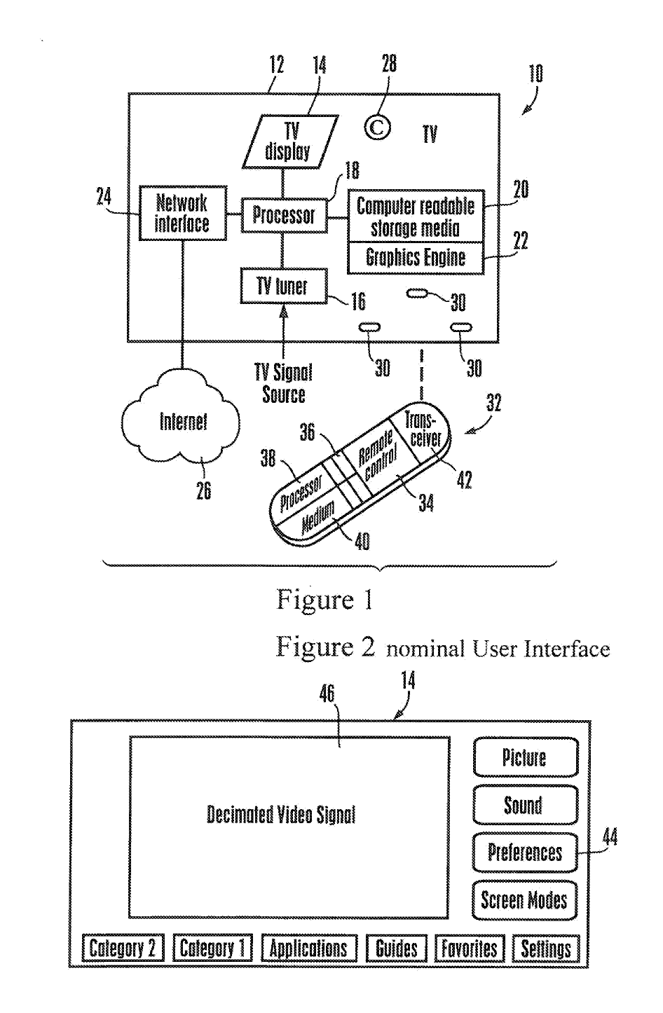

Now referring to FIG. 2, when a viewer wishes to operate the TV UI he appropriately manipulates the RC 32 to cause the UI shown in FIG. 2 to appear. The TV processor arranges UI elements 44 in a graphics plane by accessing the graphics module 22 and then overlays the graphics plane onto a video plane in which is presented TV video programming 46, in some cases in decimated format as appropriate for the smaller size of the video window in the UI mode relative to its size when no graphics are presented.

In the non-limiting example UI shown, UI elements representing category types are arranged in a row along the bottom of the TV display 14 while items within a selected category (i.e., the category at the right of the row) are arranged in a column above the selected category as shown. In the example shown, the selected category is “settings” and the items in that category are “picture”, “sound”, “preferences”, and “screen modes”. A viewer can manipulate the RC 32 to move left and right between categories to select which category will be “selected” (in the example shown, presented as the right-most category) and up and down to select a desired item for further options and menus. In this way, the viewer can establish settings for picture presentation, sound presentation, and so on.

The UI shown in FIG. 2 is a nominal UI. It assumes that the viewer is located directly in front of the TV display 14, i.e., along a normal to the center of the display 14, and at a nominal distance “d1” or closer. The UI elements 44 are presented in a nominal size and arranged with a nominal number of UI elements 44 shown. The graphics plane has a zero y-axis angle relative to the video plane.

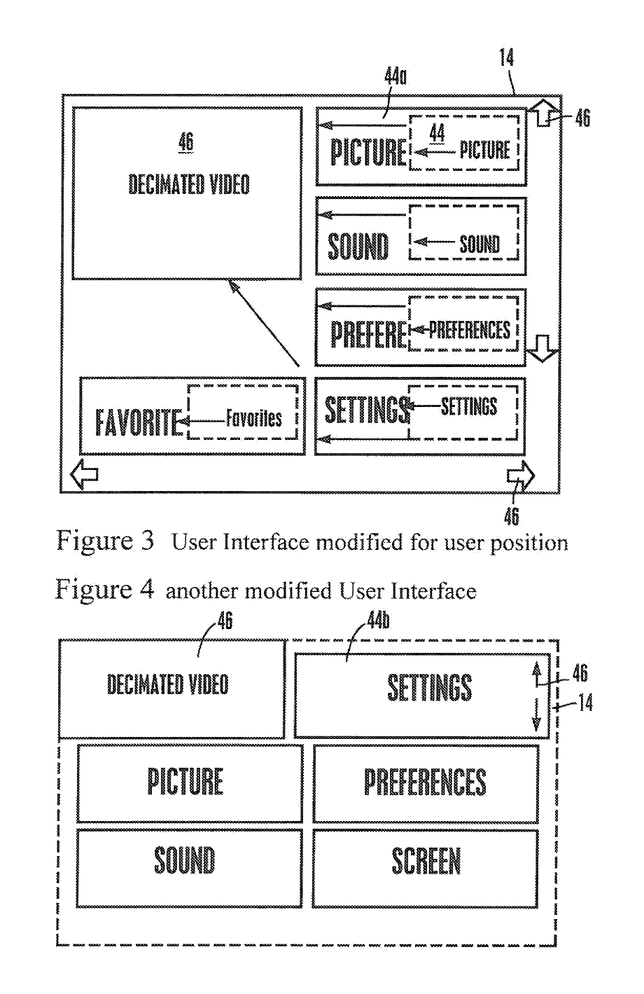

In contrast, FIG. 3 shows that the UI may be re-sized and re-configured in accordance with principles below to account for the viewer being positioned beyond the nominal distance “d1” and in some embodiments for being laterally distanced from the normal of the display so that the viewer looks at the display 14 from an oblique angle. For illustration FIG. 3 shows the nominally-sized UI elements 44 in phantom and the re-sized elements 44a in solid, it being understood that only the re-sized elements 44a actually appear on screen. As shown, the re-sized UI elements 44a are larger and contain larger lettering than the nominal elements 44. Also, because of the larger size, fewer re-sized elements 44a are displayed in FIG. 3 in both the category row and item column than the number of nominal elements 44 in FIG. 2. Additionally, to alert the viewer that unshown categories and items within the selected category are available for selection, arrows 46 appear on the UI that can be selected by a viewer manipulating the RC 32 to move the categories (and/or items) cause some unshown categories (and/or items) to move into view while a like number of categories (and/or items) move out of view.

FIG. 4 shows yet larger UI elements 44b which are even larger than the elements 44a of FIG. 3. Furthermore, because of the large size of the UI elements 44b, only a single category (the selected category, in this example, “settings”) appears, with the corresponding category items arranged in a grid beneath the selected category. As was the case in FIG. 3, in FIG. 4 arrows 46 can appear to enable a viewer to select another category for view. Thus, not only may UI elements be re-sized, but they may be positionally rearranged on the graphics plane to account for extraordinary size. The change of arrangement of UI elements from that shown in FIG. 3 to that shown in FIG. 4 may be invoked when viewer distance exceeds an empirically determined “rearrange” distance that is greater than the nominal distance “d1”.

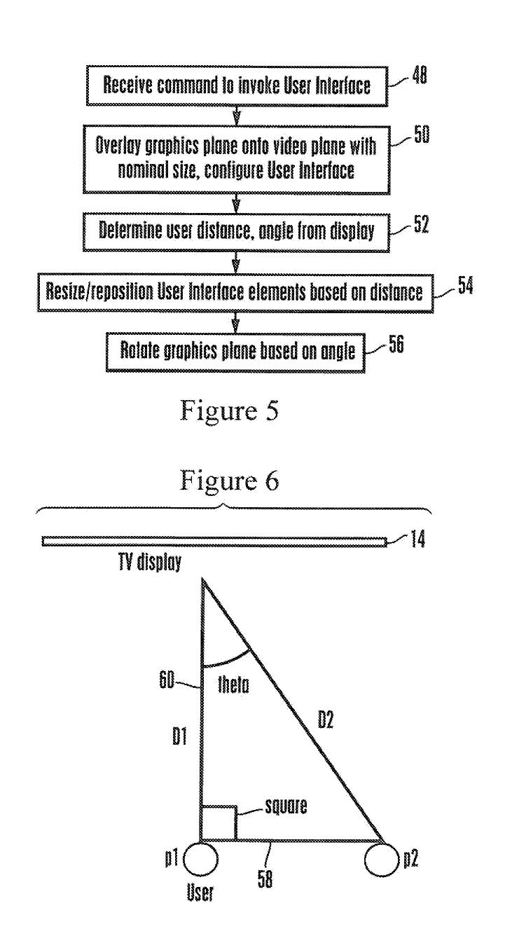

FIG. 5 illustrates example logic in flow chart format for explanation only and not by way of limitation. Commencing at block 48 a command is received from the RC 32 by the TV processor 18 via the RC transceiver 42 and wireless receiver(s) 30 to invoke the UI. In response, at block 50 the nominal UI shown in FIG. 2 is arranged on the graphics plane and the graphics plane is overlaid on the video plane.

Proceeding to block 52, the distance of the viewer and in some embodiments the angle of the viewer relative to the normal of the TV display 14 is determined. Based on these determinations, assuming the current distance of the viewer from the TV display 14 is greater than the nominal distance “d1”, at block 54 the UI elements 44 are resized and in some cases as explained above repositioned in the graphics plane to produce, e.g., the views shown in FIG. 3 or 4. In one non-limiting example, the UI elements 44 and lettering therein may be enlarged relative to the nominal sizes of the elements and lettering by a simple ratio of d/d1, where “d” the current distance of the viewer from the TV display 14. Other heuristics may be used for determining new sizes of the UI elements.

Further, in embodiments in which the angle of the viewer relative to the normal defined by the TV display 14 is determined, at block 56 the graphics plane is rotated on the y-axis with respect to the video plane toward the viewer by an angular amount proportional to the viewer's angle from the display.

In one implementation, the viewer distance from the TV is determined by the RC processor 38 by measuring the time difference between transmission of a command and receipt of a reflection of that command from the TV and then converting the time difference (“t”) to a distance using the speed of light (“c”) in the equation d=ct. The RC then sends the calculated distance to the TV for UI element re-sizing/repositioning. In another implementation, the distance may be determined by the TV processor 18 by triangulation using plural wireless receivers 30. The TV processor 18 knows the distance between receivers 30 on the chassis 12 and can convert the time difference between receipt of signals at the receivers 30 to distances as part of the triangulation process using the above equation of d=ct. Again using triangulation, when only two wireless receivers 30 are provided both the distance calculated by the RC processor and the time difference between signal receipt by the wireless receivers 30 and the fixed distance between the receivers 30 can be used to determine the user position and, thus, not only the distance of the viewer from the display 14 but also the angle of the viewer relative to the display.

Yet again, the angle of the viewer (i.e., the viewer's lateral offset from the normal to the display) may be determined using image recognition of the image signal from the camera 28 in conjunction with a distance determination as described above. When only a single person is recognized to be in the camera's field of view in accordance with image recognition principles known in the art, that person is assumed to be the viewer, and the person's lateral displacement from the normal to the display is converted to an angle by the TV processor by determining the angle between the normal of the display and a line of sight from the normal of the display (on which the camera 28 may be disposed for ease of calculation) to the imaged person. If multiple people are in the camera's view, the human image with arm extended toward the TV can be assumed to be the viewer. The above methods may be combined for refined distance/orientation calculations.

Yet again, a proximity sensor may be provided on the RC 32 that can be detected by a sensor on the TV communicating with the TV processor 18 to detect distance of the viewer from the TV.

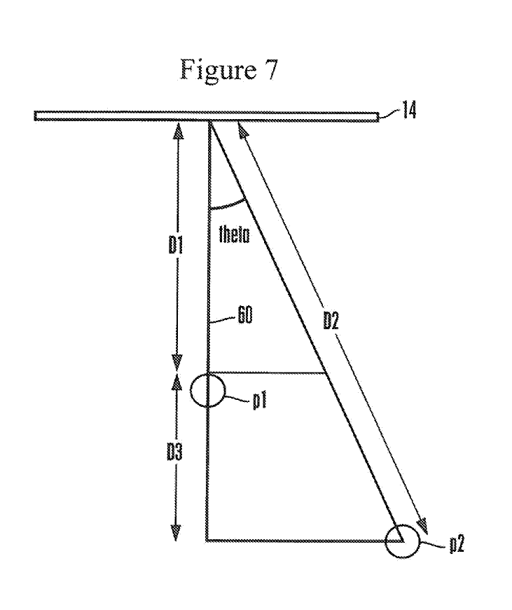

FIGS. 6 and 7 illustrate two example non-limiting methods by which the RC processor 38 may determine the viewer's distance from the TV and angle “theta” relative to the normal of the display, prior to sending the calculated distance to the TV for UI element re-sizing. In FIG. 6, the RC processor 38 assumes that the viewer has moved parallel to the plane of the display 14 along a line 58 to an oblique position “p2”, away from the display normal 60 and the nominal viewer position “p1” at the nominal distance “D1”. Thus, the distance “D2” derived as described above from the time difference between wireless signal transmission and receipt of the signal reflection is the hypotenuse of a right triangle; “D1” and “D2” being known, the viewer angle “theta” is determined to be the arccosine of D1/D2. This represents an approximation of the actual viewer angle since the viewer may not have moved exactly parallel to the display.

In FIG. 7, on the other hand, a more general case is illustrated in which the viewer is not assumed to have moved parallel to the display 14. In the hypothetical of FIG. 7, the viewer has moved back and right of the normal. In this case, the RC processor assumes that the viewer has changed angular position as opposed to simply moving directly away along the normal 60 of the display, as assumption that is expected to be accurate much of the time. In this case, the following equation is used, again with “D2” representing the calculated distance using the above-defined wireless signal time differences: D3=(D2−D1)*K, wherein K is heuristically determined to dampen graphics plane rotation as appropriate not to lose overmuch UI element presentation at the edges of the graphic plane that is being turned away. The viewer angle theta is the arccosine of ((D1+D3)/D2).

Re-sizing and repositioning of UI elements can stop at a predetermined maximum viewer distance. Likewise, rotation of the graphics plane on the y-axis relative to the video plane may cease after the viewer exceeds a predetermined maximum oblique angle (e.g., sixty degrees) from display normal.

Present principles may be used for re-sizing UIs for game consoles. Present principles can also be used to facilitate the use of gestures recognition and hand tracking user interface systems. The advantages of orientation change (angular rotation of the graphics plane) become more apparent with 3D stereoscopic displays because the graphics plane carrying the UI can be offset in its Z depth to be closer than the video plane in which case the changes in the UI based on the change in the orientation of viewer becomes very helpful and apparent.

While the particular RESIZING TV GRAPHIC ELEMENTS AND REORIENTING GRAPHICS PLANE FOR USER POSITION is herein shown and described in detail, it is to be understood that the subject matter which is encompassed by the present invention is limited only by the claims.

What is claimed is:

1. TV comprising:
display defining a display plane and a normal to the display plane;
processor communicating with a TV tuner and controlling presentation on the display;
computer readable storage medium accessible to the processor and storing logic causing the processor to:
present user interface (UI) elements in a graphics plane presented on the display along with a video plane presenting video content, the UI elements being presented in a nominal size and nominal layout; and
responsive to a determination that a viewer is positioned at an oblique angle relative to the normal, rotating the graphics plane relative to the video plane.

2. The TV of claim 1, wherein the logic causes the processor to enlarge the UI elements from the nominal size responsive to a determination that a distance between the viewer and TV exceeds a nominal distance.

3. The TV of claim 1, wherein the logic causes the processor to rearrange UI elements in the graphics plane relative to each other responsive to a determination that a distance between the viewer and TV exceeds a rearrange distance.

4. The TV of claim 3, wherein the logic causes the processor to show fewer UI elements than are shown in the nominal layout responsive to a determination that a distance between the viewer and TV exceeds the rearrange distance.

5. The TV of claim 1, wherein responsive to a determination that a distance between the viewer and TV exceeds a nominal distance, the logic causes the processor to add to the UI arrows indicating that additional unshown UT elements are available for display.

6. The TV of claim 1, wherein the TV processor receives a viewer distance determination from a remote control (RC) wirelessly communicating commands to the TV.

7. The TV of claim 1, wherein the processor receives image signals from a camera on the TV and responsive thereto determines a viewer angle relative to the normal.

8. The TV of claim 1, wherein the processor receives command signals from plural wireless command signal receivers and based on time differences between receipt of signals from the respective receivers, determines at least a viewer distance from the TV.

9. Method comprising:
determining a distance of a viewer from a TV;
based on the distance, altering a size of at least one user interface (UI) element presented on a display of the TV; and
undertaking at least one of:
responsive to a determination that the distance exceeds a rearrange distance, rearranging UI elements on the display relative to each other;
responsive to a determination of a viewer angle relative to a normal to a plane defined by the display, altering an apparent angle at which UI elements are made to appear on the display.

10. The method of claim 9, wherein the method comprises responsive to a determination that the distance exceeds a rearrange distance, rearranging UI elements on the display relative to each other.

11. The method of claim 9, wherein the method comprises responsive to a determination of a viewer angle relative to a normal to a plane defined by the display, altering an apparent angle at which UI elements are made to appear on the display.

12. The method of claim 11, wherein the UI elements are presented in a graphics plane and the act of altering an apparent angle at which UI elements are made to appear on the display includes rotating the graphics plane with respect to a video plane presented on the display and carrying video content.

13. The method of claim 10, wherein the method comprises showing fewer UI elements than are shown in a nominal layout responsive to a determination that a distance between the viewer and TV exceeds the rearrange distance.

14. The method of claim 9, wherein responsive to a determination that a distance between the viewer and TV exceeds a nominal distance, the method comprises adding arrows to the presentation on the display indicating that additional unshown UI elements are available for display.

15. Assembly comprising:
display receiving video signals;
processor communicating with the display; and
computer readable medium bearing instructions executable by the processor to:
responsive to a determination that a distance between a viewer and the assembly exceeds a rearrange distance, rearrange user interface (UI) elements on the display relative to each other; and
responsive to a determination of a viewer angle relative to a normal to a plane defined by the display, alter an apparent angle at which UI elements are made to appear on the display.

16. The assembly of claim 15, wherein the logic causes the processor to, based on a distance between a viewer and the assembly, alter a size of at least one UI element presented on a display of the TV.

17. The assembly of claim 15, wherein responsive to a determination that a viewer is positioned at an oblique angle relative to the normal, the processor rotates a graphics plane in which the UI elements appear relative to a video plane in which video content appears.

18. The assembly of claim 16, wherein the logic causes the processor to enlarge the UI elements from a nominal size responsive to a determination that a distance between the viewer and TV exceeds a nominal distance.

19. The assembly of claim 15, wherein the logic causes the processor to show fewer UI elements than are shown in a nominal UI layout responsive to a determination that a distance between the viewer and TV exceeds the rearrange distance.

20. The assembly of claim 16, wherein responsive to a determination that a distance between the viewer and TV exceeds a nominal distance, the logic causes the processor to add to the UI arrows indicating that additional unshown UI elements are available for display.
